(19) United States
(12) Patent Application Publication
(10) Pub. No.: US 2013/0081579 A1
(43) Pub. Date: Apr. 4, 2013

(54) WASTE BAG RETENTION DEVICE AND SYSTEM

(71) Applicant: Kelly McLaughlin, Encinitas, CA (US)

(72) Inventor: Kelly McLaughlin, Encinitas, CA (US)

(21) Appl. No.: 13/249,150

(22) Filed: Sep. 29, 2011

(51) Int. Cl. A01K 29/00; A01K 27/00

(52) U.S. Cl. 119/795; 119/174

(57) ABSTRACT

A retention device comprises a fabric strip and a retention mechanism. The retention device has a first end and a second end. The retention mechanism includes a loop member attached to the fabric strip at one or more of the first end and the second end. A locking mechanism is slidably coupled to the loop member and adapted to tighten the loop member. A waste bag carrying system comprises a retention device and a pet leash having a lead portion and a handle portion.

### FIELD

The present disclosure relates to devices, systems and methods for holding waste disposal bags on a pet leash.

### BACKGROUND

Many municipalities have ordinances that require pet owners to clean up after their pets and make sure pet waste is disposed of properly. These mandates often extend to sidewalks, parks, and other public areas. When taking their pets for walks in these areas, pet owners often keep their pets on a leash. Thus, pet owners need to hold the leash in one hand while walking their pets. If they need to hold a bag of pet waste as well, that leaves the pet owners with no free hand for other activities such as using a cell phone or PDA. It is also common for pet owners to engage in outdoor exercise, such as jogging, with their pets, which makes it unfeasible to carry a bag of pet waste. In addition, it can simply be unpleasant and unsightly to hold a bag of pet waste.

Devices have been designed to obviate the need for pet owners to carry pet waste bags while walking their pets. In particular, there are existing devices to attach the pet waste bag to the pet leash. Such solutions include securing devices having one or more arms that attach to a pet leash. These devices can be awkward to use because a first arm has to be disengaged from the leash and the waste bag pulled through the leash and the first arm of the securing device, over a focal point, and then through the leash and a second arm. Other devices include a flexible planar body with an attachment surface for securing the body to a pet leash and a plurality of slits extending through the body and intersecting a common aperture through which a waste bag is inserted. These devices are large so they may hang down and contact the pet and may be awkward to use as well.

Accordingly, there is a need for a device and system for holding waste bags on a pet leash that are easy to use. There also is a need for a device and system for holding waste bags on a pet leash that is compact and integrates easily into a pet leash.

### SUMMARY

The present disclosure, in its many embodiments, alleviates to a great extent the disadvantages of known waste bag holding devices by providing retention devices, systems and methods which can be integrated with or coupled to a leash. Disclosed retention devices, systems and methods comprise a fabric strip made of leash material and a retention mechanism that is effective and easy to use. The retention mechanism includes an elastic cord and a locking mechanism.

Exemplary embodiments of a retention device comprise a fabric strip having a first end and a second end and a retention mechanism attached to the fabric strip at one or more of the first end and the second end. The fabric strip may be comprised of a leash material. One or more of the first or second end of the fabric strip may comprise an elastic material. The retention mechanism preferably includes a loop member and a locking mechanism slidably coupled to the loop member. The locking mechanism is adapted to tighten the loop member. Exemplary embodiments may further comprise a stop slidably coupled to the loop member, and the stop may be in the faun of a bead.

In exemplary embodiments, the fabric strip of the retention device is integrated with a pet leash. More particularly, the first end of the fabric strip may be located adjacent a handle portion of the pet leash, and the loop member may be attached at or near the second end of the fabric strip. In exemplary embodiments, the fabric strip is flush with the pet leash. The fabric strip may be coupled to the pet leash. In exemplary embodiments, the first end and second end of the fabric strip are attached to form a ring. The ring may be coupled to a handle portion of a pet leash.

Exemplary embodiments include a waste bag carrying system comprising a pet leash having a lead portion and a handle portion and a retention device. The retention device has a fabric strip including a first end and a second end and a retention mechanism. The retention mechanism is attached to the fabric strip at one or more of the first end and the second end. The retention mechanism includes an elastic cord member and a locking mechanism slidably coupled to the elastic cord member and adapted to tighten the elastic cord member. The system may further comprise a stop slidably coupled to the elastic cord member.

In exemplary embodiments, the fabric strip of the retention device is integrated with the pet leash. More particularly, the first end of the fabric strip is located adjacent the handle portion of the pet leash, and the elastic cord member is attached at or near the second end of the fabric strip. The fabric strip may be flush with the lead portion of the pet leash. The fabric strip may be coupled to the pet leash. In exemplary embodiments, the first end and second end of the fabric strip are attached to form a loop, and the loop is coupled to the handle portion of a pet leash.

Exemplary embodiments include a method of carrying a waste bag, comprising providing a pet leash having a lead portion and a handle portion, providing a retention device, coupling the retention device to the pet leash, and inserting a waste bag in the retention device. The retention device has a fabric strip and a retention mechanism, and the retention mechanism further includes a loop member and a locking mechanism slidably coupled to the loop member. The fabric strip of the retention device is coupled to the pet leash. Then a waste bag is inserted into a substantially circular loop formed by the loop member, and the loop member is tightened using the locking mechanism.

In exemplary embodiments, coupling the fabric strip of the retention device to the pet leash comprises integrating the fabric strip with the pet leash such that a first end of the fabric strip is located adjacent the handle portion of the pet leash and the fabric strip is flush with the lead portion of the pet leash. In exemplary embodiments, coupling the fabric strip of the retention device to the pet leash comprises attaching a first end and second end of the fabric strip to form a ring and coupling the ring to the handle portion of the pet leash. Tightening the loop member may comprise sliding the locking mechanism along the loop member until the waste bag is securely held by the elastic cord member and may further comprise contacting the waste bag with a stop slidably coupled to the elastic cord member.

Accordingly, it is seen that waste bag carrying devices, systems and methods are provided which are easy to use, compact and integrate easily into a pet leash. These and other features and advantages will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a side view of an embodiment of a waste bag carrying system in accordance with the present disclosure;

FIG. 2 is a close-up perspective view of an embodiment of a retention device in accordance with the present disclosure;

FIG. 3 is a perspective view of an embodiment of a retention device in accordance with the present disclosure shown holding a waste bag;

FIG. 4 is a close-up perspective view of an embodiment of a retention device in accordance with the present disclosure shown holding a waste bag;

FIG. 5 is a side view of an embodiment of a waste bag carrying system in accordance with the present disclosure shown holding a waste bag;

FIG. 6 is a close-up perspective view of an embodiment of a retention device in accordance with the present disclosure

FIG. 7 is a perspective view of an embodiment of a retention device in accordance with the present disclosure shown holding a waste bag;

FIG. 8 is a close-up perspective view of an embodiment of a retention device in accordance with the present disclosure shown holding a waste bag;

FIG. 9 is a side view of an embodiment of waste bag carrying system in accordance with the present disclosure shown holding a waste bag;

FIG. 10 is a front perspective view of an embodiment of a locking mechanism in accordance with the present disclosure;

FIG. 11 is a rear perspective view of an embodiment of a locking mechanism in accordance with the present disclosure; and

FIG. 12 a top view of an embodiment of a locking mechanism in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

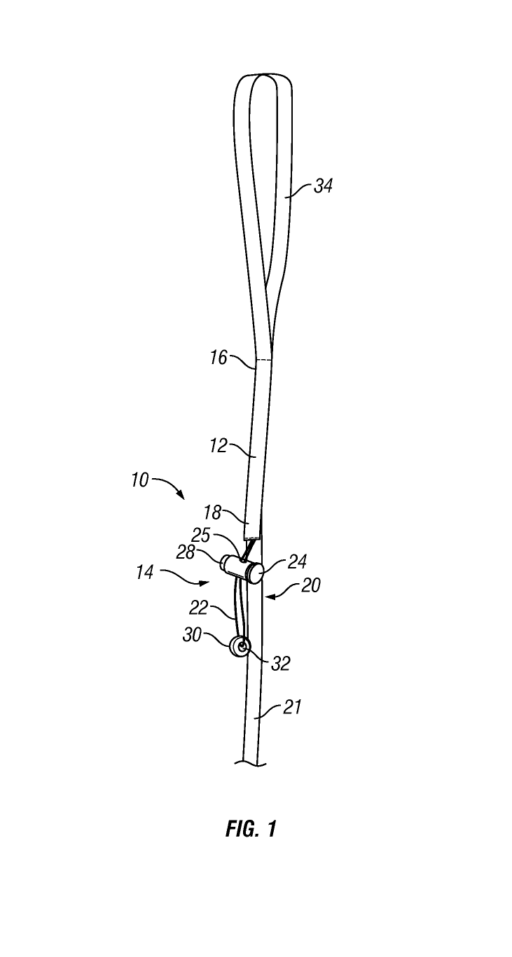

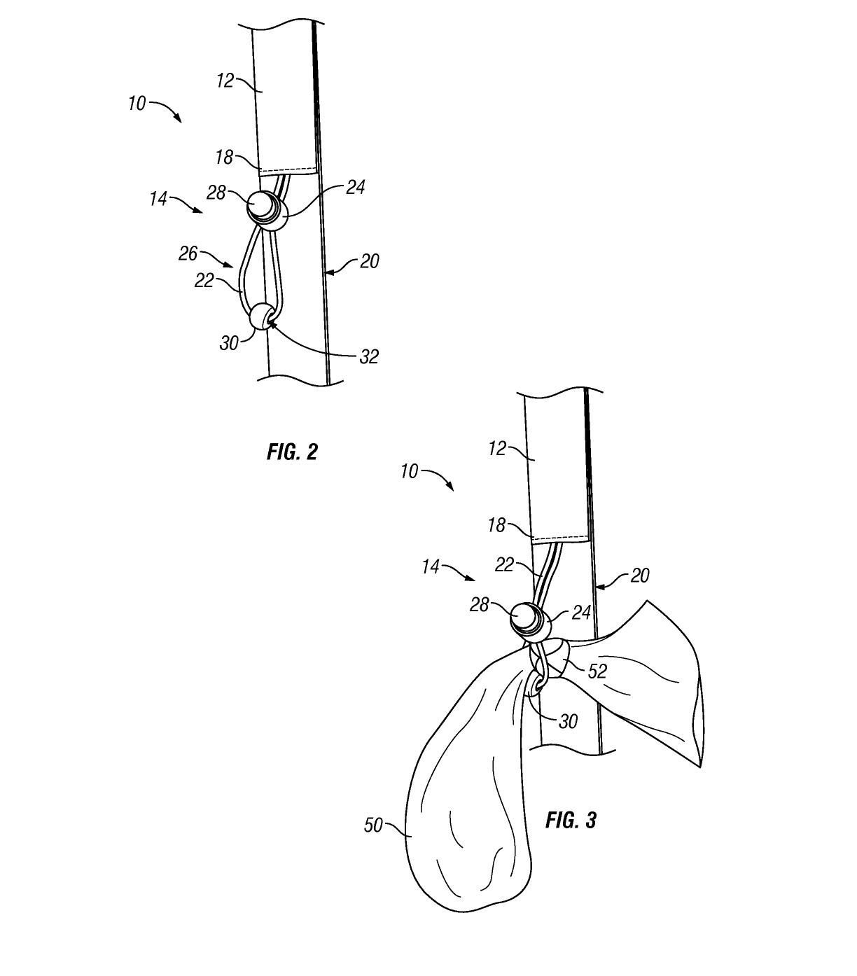

FIGS. 1 and 2 show an exemplary embodiment of a retention device 10 that generally comprises a fabric strip 12 and a retention mechanism 14 attached to the fabric strip. The fabric strip 12 has a first end 16 and a second end 18. Any material of sufficient strength and flexibility could be used for the fabric strip 12. In exemplary embodiments, the fabric strip 12 is made of nylon or other leash material, i.e., materials typically used for pet leash leads and/or handles. The fabric strip 12 may be coupled to or integrated with a pet leash 20 as described in more detail herein.

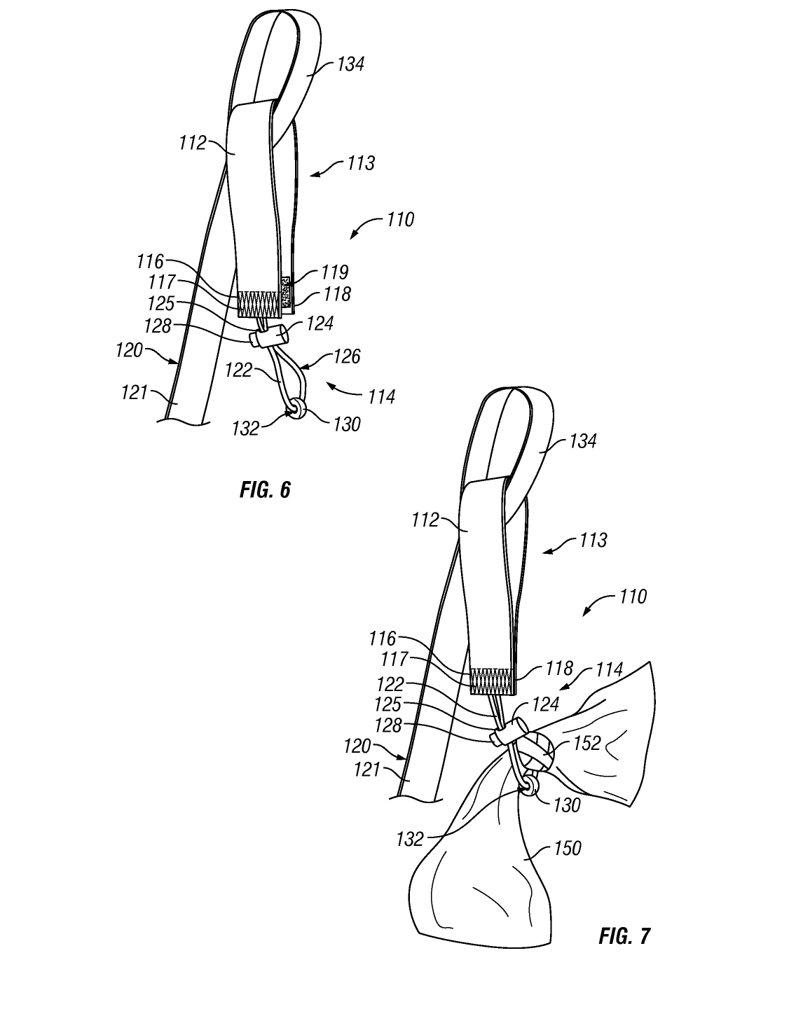

Exemplary embodiments of a retention mechanism will be described with reference to FIGS. 2 and 6. Retention mechanism 14 includes a loop member 22 and a locking mechanism 24 slidably coupled to the loop member 22. Those skilled in the art will appreciate that the loop member could comprise an elastic cord, or other materials like non-elastic cords, cloth strips and elastic strips could be used. The loop member 22 forms a substantially circular loop 26 with the ends of the loop member 22 inserted through the locking mechanism 24. Any type of locking mechanism could be used in conjunction with the loop member 22 so long as the locking mechanism can slide along the loop 26 and tighten the loop member 22 by reducing the size of the loop 26.

An exemplary embodiment of a locking mechanism 24 is a slidable button lock wherein when button 28 is pressed down, the locking mechanism 24 is in an unlocked position and may be slid along the loop member 22. When the button 28 is released the locking mechanism 24 is in a locked position and remains stationary, maintaining the size of the ring 26. A through hole 25 receives two cords of the loop member 22. The locking mechanism 24 may also include a stop 30, which can be slidably coupled to the elastic cord member 22 by inserting the cord member through a through hole 32 in the stop 30. The stop 30 could vary in shape and size, and in exemplary embodiments is a bead.

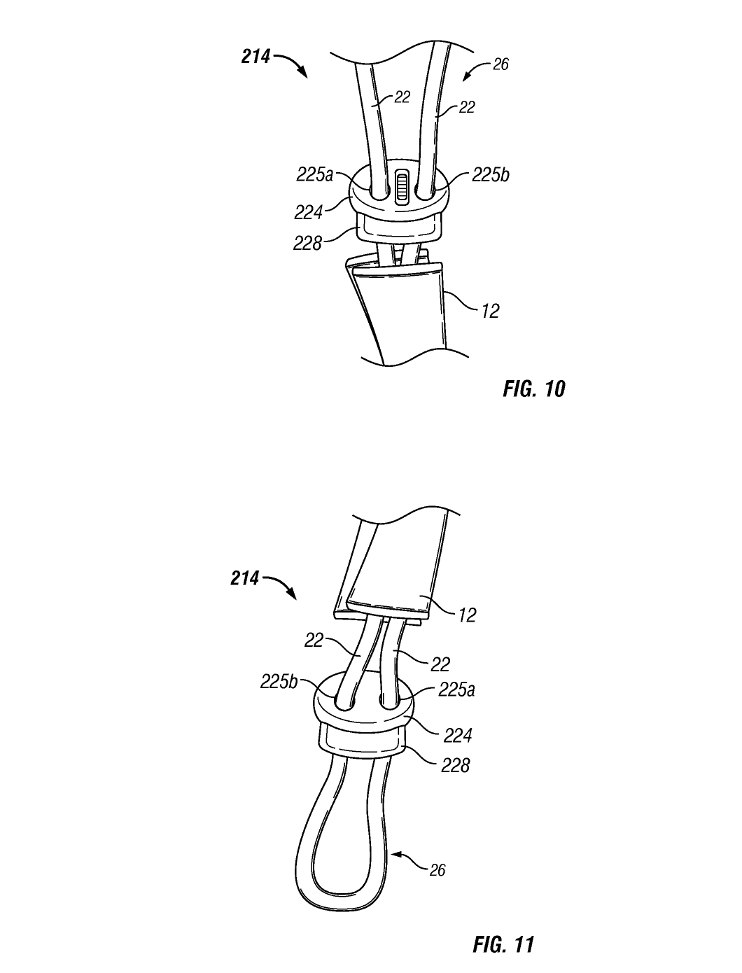

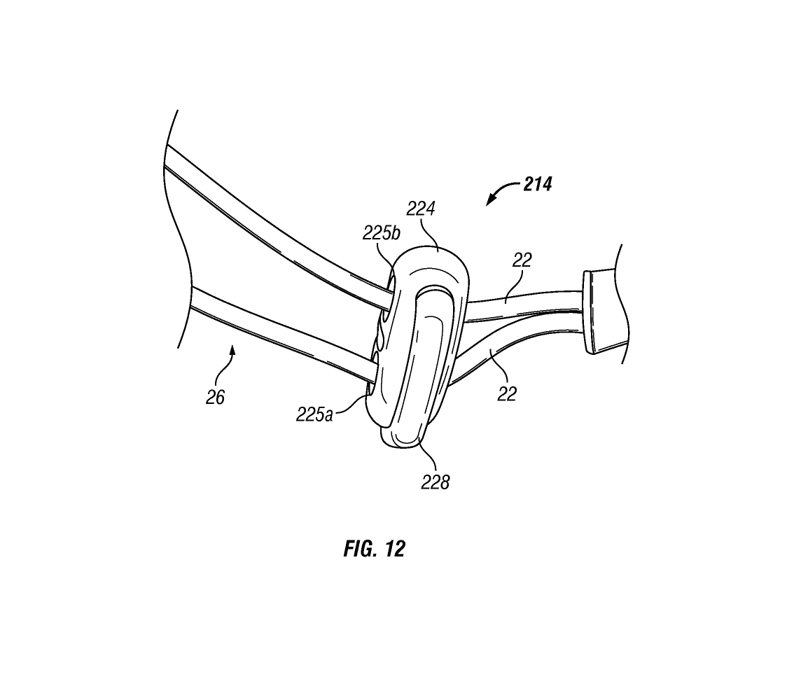

Another exemplary embodiment of a retention mechanism 214 incorporates a different locking mechanism 224 shown in FIGS. 10-12. Locking mechanism 224 defines two through holes 225a, 225b, each of which receives a single cord of loop member 22. Each cord of the loop member 22 is thus kept separate from the other within the locking mechanism 224. Exemplary embodiments of a locking mechanism 224 are ovular, though the locking mechanism can be any shape so long as it is wide enough to have two through holes 225a, 225b to separately accommodate each cord of the loop member 22. A button member 228 is pressed down to an unlocked position, allowing the locking mechanism 224 to slide along the cords of the loop member 22. When the button member 228 is released it is in a locked position and remains stationary to maintain the size of the loop 26 so the loop member 22 can hold a waste bag. The button member 228 is sized to be wide enough to lock and unlock both through holes 225a, 225b. Due to its ability to accommodate both cords of the loop member 22, locking mechanism 224 can operate to hold a waste bag without a stop.

The retention mechanism 14 is attached to the fabric strip 12 of the retention device 10 through a connection of the loop member 22 with the first end 16 and/or second end 18 of the fabric strip 12. More particularly, in exemplary embodiments the ends of the loop member 22 are inserted through the locking mechanism 24 and are then attached to the second end 18 of the fabric strip 12. The ends of the loop member 22 can be fastened to the second end 18 of the fabric strip 12 by any fastening methods or mechanisms, including by application of adhesives or by being sown together. In some embodiments, the ends of the loop member 22 are fastened to the second end 18 of the fabric strip 12 while in other embodiments the ends of the loop member 22 may be inserted between and fastened to both the first end 16 and the second end 18 of the fabric strip 12. As mentioned above, the loop member 22 may be an elastic cord to provide a more secure hold on a waste bag.

In exemplary embodiments, as shown in FIGS. 1-4, the fabric strip 12 is integrated with a pet leash 20. More particularly, the fabric strip 12 is adjacent the pet leash 20 and oriented in the same longitudinal plane as a proximal portion of the lead 21 of the pet leash 20 extending distally from the handle portion 34 of the leash 20. Thus, the proximally located first end 16 of the fabric strip 12 is adjacent a handle portion 34 of the pet leash 20, and the second end 18 of the fabric strip 12 is located distally a short distance along the lead of the leash 20. In exemplary embodiments, the fabric strip 12 is attached so the sides of the strip and the sides of the pet leash 20 are flush, and it forms a seamless integration with the leash. This attachment could be effected using glue or other adhesives, or the fabric strip 12 could be sewn onto the pet leash 20.

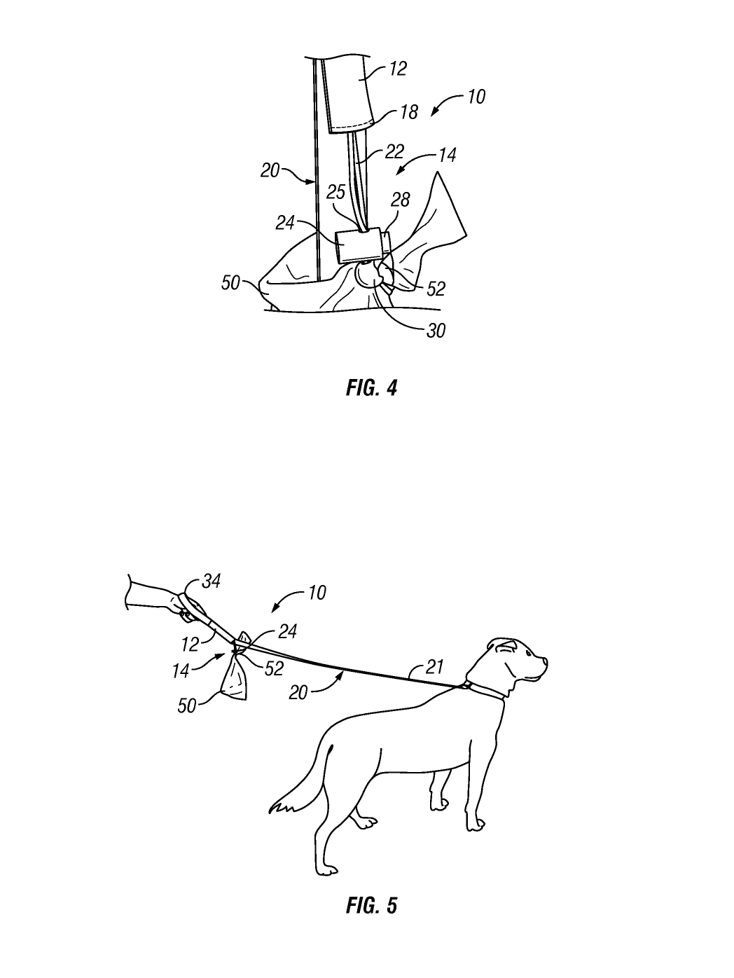

As best seen in FIGS. 2 and 4, in exemplary integrated embodiments the retention mechanism 14 is attached to the second end 18 of the fabric strip 12. More particularly, the ends of the loop member 22 are disposed underneath the second end 18 of the fabric strip 12 between the fabric strip and the pet leash 20. The ends of the loop member 22 may be sewn or glued to the second end 18 of the fabric strip 12. Thus, the retention mechanism 14 extends from the second end 18 of the fabric strip 12 and may rest on a portion of the pet leash 20. As best seen in FIGS. 1 and 2, the locking mechanism 24 of the retention mechanism 14 may sit on the pet leash 20. When the leash is being used and the retention device 10 is holding a waste bag, the retention mechanism 14 hangs down from the leash 20, as shown in FIG. 5.

With reference to FIGS. 6-9, exemplary embodiments of a retention device coupled to a leash handle will be described. In these embodiments, the fabric strip 112 of retention device 110 forms a closed ring 113, which is coupled to the handle portion 134 of leash 120. More particularly, the fabric strip 112 in its closed ring 113 faun interlocks with the leash handle 134 and hangs therefrom. The first end 116 and second end 118 of the fabric strip 112 may have a releasable securing mechanism 119 such as a Velcro patch to allow the user to open and close the ring 113 and fasten and unfasten the fabric strip 112 to the leash handle 134. Alternatively, the first end 116 and second end 118 of the fabric strip 112 may be permanently fastened together around the leash handle 134, either by sewing or using glue or other adhesives. Exemplary embodiments of a retention device may include elastic portions 117 sewn onto the first end 116, second end 118 or both ends of the fabric strip 112. These elastic portions 117 reduce wear and tear on the retention device by providing stretching capability when the waste bag is being carried.

In exemplary embodiments, the retention mechanism 114 is attached to the fabric strip 112 at or near the point where the first and second ends 116, 118 of the fabric strip 112 are attached to form the closed loop 113. More particularly, the ends of the loop member 122 of the retention mechanism 114 are disposed between the first and second ends 116, 118 of the fabric strip 112. The ends of the loop member 122 are fastened to inner portions of the fabric strip 112 at or near one or both of the first and second ends 116, 118 of the fabric strip, either by sewing or gluing. The locking mechanism 124 of the retention mechanism 114 and stop 130 are slidably coupled to the loop member 122 by insertion of the cords of loop member 122 through through hole 125. When the leash 120 is being used and the retention device 110 is holding a waste bag, the retention mechanism 114 hangs down from the leash handle 134, as shown in FIG. 9.

In operation, after the pet waste is in the waste bag 50 the user closes the top of the waste bag 50 by, e.g., tying a quick knot, and then secures the waste bag 50 using the retention mechanism 14 of the retention device 10. More particularly, the user inserts the top portion 52 of the waste bag 50 through the ring 26 formed by the loop member 22 of the retention mechanism 14. To secure the waste bag 50, the user presses button 28 of the button lock mechanism 24 so the locking mechanism 24 is in an unlocked position. The user then slides the locking mechanism 24 along the loop member 22 toward the top portion 52 of the waste bag 50 until the locking mechanism 24 is pushed tightly against the top portion 52 of the waste bag 50.

As best seen in FIG. 4, the portion of the loop member 22 between the locking mechanism 24 and stop bead 30 is tightened around the top portion 52 of the waste bag 50 such that the stop bead 30 and the locking mechanism 24 press against the bag from opposite ends, and the bag is thus held tightly. The user then releases button 28 of the button lock mechanism 24 so the locking mechanism 24 is in a locked position and maintains the tightness of the loop member around the top portion 52 of the waste bag 50. The user can then continue walking his or her pet with the waste bag 50 hanging from the retention device 10, as shown in FIG. 5. Alternatively, using a retention mechanism 214 without a stop, the user would press button 228 of locking mechanism 224 and slide the locking mechanism 224 until it presses against the waste bag 50.

To remove the waste bag 50 from the retention device 10, the user first presses button 28 or 228 of the button lock mechanism 24 or 224 so the locking mechanism 24 is in an unlocked position. Then the user slides the locking mechanism 24 or 224 along the loop member 22 away from the waste bag 50 in the direction of the fabric strip 12 until the locking mechanism 24 or 224 is far enough away from the top portion 52 of the waste bag 50 so the waste bag can be removed from the retention mechanism 14 or 214. The top portion 52 of the waste bag 50 is then slid out of the loop member 22, and the bag removed and disposed of.

Operation of exemplary embodiments of a retention device coupled to a leash handle will now be described in connection with FIGS. 7-9. To attach the retention device 110 to the pet leash 120, the user threads the first or second end 116, 118 of the fabric strip 112 through the leash handle 134. Using the releasable securing mechanism 119, which may be a Velcro patch, the user fastens the first and second ends 116, 118 of the fabric strip 112 together to form a closed loop 113 coupled to the leash handle 134. It should be noted that the user could attach the retention device 110 to the leash 134 at any location along the length of the leash lead 121.

Once the pet waste is in the waste bag 150 the user closes the top of the waste bag 50 and secures it using the retention mechanism 114 of the retention device 110. This is accomplished by inserting the top portion 152 of the waste bag 150 through the ring 126 formed by the elastic cord member 122 of the retention mechanism 114. The user then presses button 128 of the button lock mechanism 124 so the locking mechanism 124 is in an unlocked position, thereby securing the waste bag 150. The user then slides the locking mechanism 124 along the loop member 122 toward the top portion 152 of the waste bag 150 until the locking mechanism 124 is pushed tightly against the top portion 152 of the waste bag 150.

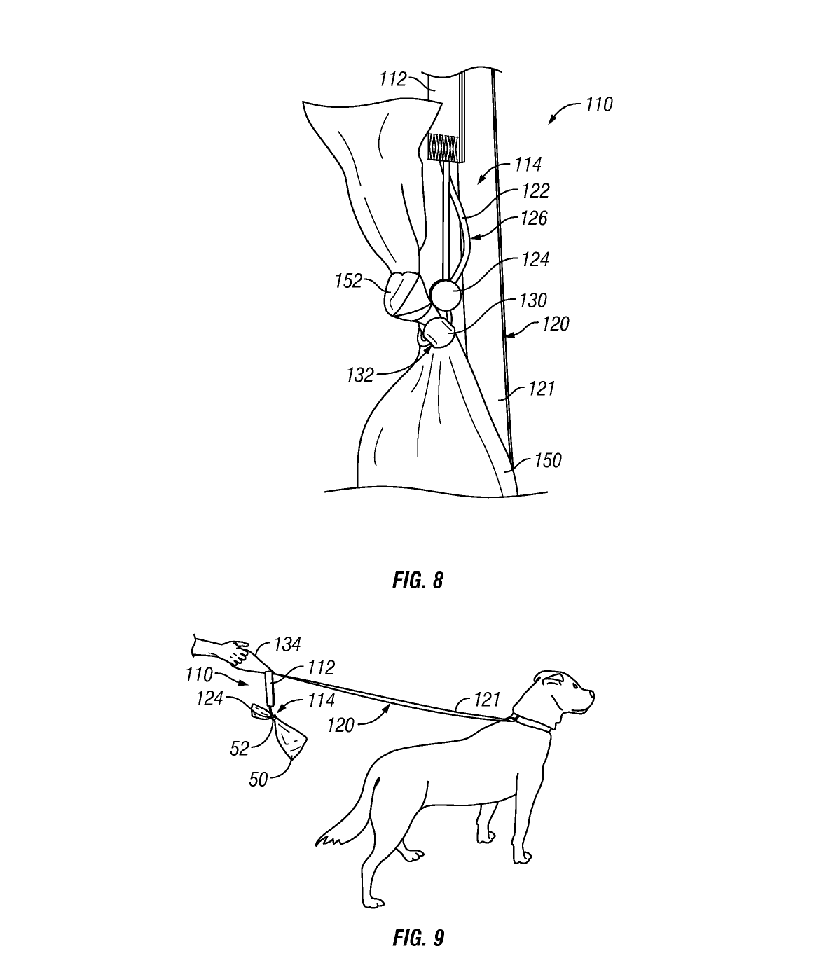

With reference to FIGS. 7 and 8, it can be seen that the bag 150 is held securely as the portion of the loop member 122 between the locking mechanism 124 and stop bead 130 tightens around the top portion 152 of the waste bag 150 such that the stop bead 130 and the locking mechanism 124 press against the bag from opposite ends. The user then releases the button 128 of the button lock mechanism 124 so the locking mechanism 124 is in a locked position and maintains the tightness of the loop member around the top portion 152 of the waste bag 150. The user can then continue walking his or her pet with the waste bag 150 hanging from the retention device 110, which, in turn, hangs from the handle portion 134 of the leach 120, as shown in FIG. 9. Alternatively, using a retention mechanism 214 without a stop, the user would press button 228 of locking mechanism 224 and slide the locking mechanism 224 until it presses against the waste bag 50.

Removal of the waste bag 150 from the retention device 110, entails unlocking the locking mechanism 124 or 224 by pressing button 128 or 224 of the button lock mechanism 124 or 224. Then the user slides the locking mechanism 124 or 224 along the loop member 122 away from the waste bag 150 in the direction of the fabric strip 112 until the locking mechanism 124 or 224 is far enough away from the top portion 152 of the waste bag 150 so the waste bag can be removed from the retention mechanism 114 or 214. The user then slides the top portion 152 of the waste bag 150 out of the elastic cord member 122 and removes the bag from the retention device 110.

Thus, it is seen that waste bag retention device, systems and methods are provided. It should be understood that any of the foregoing configurations and specialized components or may be interchangeably used with any of the apparatus or systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the disclosure.

What is claimed is:

1. A retention device comprising:
a fabric strip having a first end and a second end; and
a retention mechanism including:
a loop member attached to the fabric strip at one or more of the first end and the second end; and
a locking mechanism slidably coupled to the loop member and adapted to tighten the loop member.

2. The retention device of claim 1 further comprising a stop slidably coupled to the loop member.

3. The retention device of claim 2 wherein the stop is a bead.

4. The retention device of claim 1 wherein the fabric strip is comprised of a leash material.

5. The retention device of claim 1 wherein the fabric strip is integrated with a pet leash.

6. The retention device of claim 5 wherein the first end of the fabric strip is located adjacent a handle portion of the pet leash, and the loop member is attached at or near the second end of the fabric strip.

7. The retention device of claim 5 wherein the fabric strip is flush with the pet leash.

8. The retention device of claim 1 wherein the first end and second end of the fabric strip are attached to form a ring.

9. The retention device of claim 8 wherein the ring is coupled to a handle portion of a pet leash.

10. The retention device of claim 1 wherein the fabric strip comprises an elastic material.

11. A waste bag carrying system comprising:
a pet leash having a lead portion and a handle portion; and
a retention device having a fabric strip including a first end and a second end and a retention mechanism, the retention mechanism including:
an elastic cord member attached to the fabric strip at one or more of the first end and the second end; and
a locking mechanism slidably coupled to the elastic cord member and adapted to tighten the elastic cord member.

12. The system of claim 11 wherein the fabric strip is integrated with and flush with the lead portion of the pet leash.

13. The system of claim 12 wherein the first end of the fabric strip is located adjacent the handle portion of the pet leash, and the elastic cord member is attached at or near the second end of the fabric strip.

14. The system of claim 11 wherein the first end and second end of the fabric strip are attached to form a ring and the ring is coupled to the handle portion of a pet leash.

15. The system of claim 11 further comprising a stop slidably coupled to the elastic cord member.

16. A method of carrying a waste bag, comprising:
providing a pet leash having a lead portion and a handle portion;
providing a retention device having a fabric strip and a retention mechanism, the retention mechanism further including a loop member and a locking mechanism slidably coupled to the loop member;
coupling the fabric strip of the retention device to the pet leash;
inserting a waste bag into a substantially circular loop formed by the loop member; and
tightening the loop member using the locking mechanism.

17. The method of claim 16 wherein coupling the fabric strip of the retention device to the pet leash comprises integrating the fabric strip with the pet leash such that a first end of the fabric strip is located adjacent the handle portion of the pet leash and the fabric strip is flush with the lead portion of the pet leash.

18. The method of claim 16 wherein coupling the fabric strip of the retention device to the pet leash comprises attaching a first end and a second end of the fabric strip to form a ring and coupling the ring to the handle portion of the pet leash.

19. The method of claim 16 wherein tightening the loop member comprises sliding the locking mechanism along the loop member until the waste bag is securely held by the loop member.

20. The method of claim 19 further comprising contacting the waste bag with a stop slidably coupled to the loop member.
